(19) United States
(12) Patent Application Publication
(10) Pub. No.: US 2022/0393295 A1
(43) Pub. Date: Dec. 8, 2022

(54) POWER SUPPLY DEVICE AND BATTERY MODULE

(71) Applicants: Inventec (Pudong) Technology Corporation, Shanghai (CN); INVENTEC CORPORATION, TAIPEI (TW)

(72) Inventors: Chi-Cheng HSIAO, Taipei (TW); Yuan-Chang YANG, Taipei (TW)

(21) Appl. No.: 17/475,437

(22) Filed: Sep. 15, 2021

(30) Foreign Application Priority Data
Jun. 7, 2021 (CN) 202110628528.3

(51) Int. Cl. H01M 50/291; H01M 50/271; H01M 50/213; H01M 50/262; H01M 50/244; H01M 50/242; H01M 50/249

(52) U.S. Cl. CPC H01M 50/291; H01M 50/271; H01M 50/213; H01M 50/262; H01M 50/244; H01M 50/242; H01M 50/249; H01M 2220/20

(57) ABSTRACT

A power supply device includes a casing, a battery module, and a cover. The casing has an accommodation space. The battery module is located in the accommodation space and includes a bottom frame, a plurality of battery units, and a top frame. The bottom frame is fixed to the casing, and the battery units are located between and fixed in position by the bottom frame and the top frame. The cover is mounted on the casing and covers the accommodation space.

### CROSS-REFERENCE TO RELATED APPLICATIONS

This non-provisional application claims priority under 35 U.S.C. § 119(a) on Patent Application No(s). 202110628528.3 filed in China, on Jun. 7, 2021, the entire contents of which are hereby incorporated by reference.

### BACKGROUND OF THE INVENTION

### Technical Field of the Invention

The invention relates to a power supply device and a battery module, more particularly to a power supply device and a battery module of an electric vehicle.

### Description of the Related Art

In an electric vehicle, batteries are accommodated in a casing having great rigidity, and the casing and the batteries can be formed as a battery assembly. The casing can integrate the batteries and provide protection for the batteries, and the casing has a sufficient rigidity to be firmly fixed on a frame body of the vehicle.

However, the protection provided by the casing is insufficient to meet the requirement while the vehicle is moving. When the vehicle travels on a bumpy road, vibrations or impacts may adversely affect the batteries in the casing. Therefore, how the battery assembly resist the vibrations or impacts is one of the crucial topics in this field.

### SUMMARY OF THE INVENTION

The invention provides a power supply device and a battery module which are capable of effectively resisting the vibrations.

One embodiment of the invention provides a power supply device. The power supply device includes a casing, a battery module, and a cover. The casing has an accommodation space. The battery module is located in the accommodation space and includes a bottom frame, a plurality of battery units, and a top frame. The bottom frame is fixed to the casing, and the battery units are located between and fixed in position by the bottom frame and the top frame. The cover is mounted on the casing and covers the accommodation space.

Another embodiment of the invention provides a battery module. The battery module includes a bottom frame, a plurality of battery units, and a top frame. The battery units are located between and fixed in position by the bottom frame and the top frame.

According to the power supply device and the battery module as discussed in the above embodiment, the battery unit are located between and fixed in position by the bottom frame and the top frame, such that the bottom frame, the battery units, and the top frame together form one modular body. Therefore, the battery module of the power supply device can effectively resist the vibrations.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a perspective view of a power supply device according to one embodiment of the invention;

FIG. 2 is an exploded view of the power supply device in FIG. 1;

FIG. 3 is a cross-sectional view of the power supply device in FIG. 1;

FIG. 4 is a partial and enlarged cross-sectional view of the power supply device in FIG. 3;

FIG. 5 is another partial and enlarged cross-sectional view of the power supply device in FIG. 3; and

FIG. 6 is a partial and enlarged cross-sectional view of the power supply device in FIG. 5.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

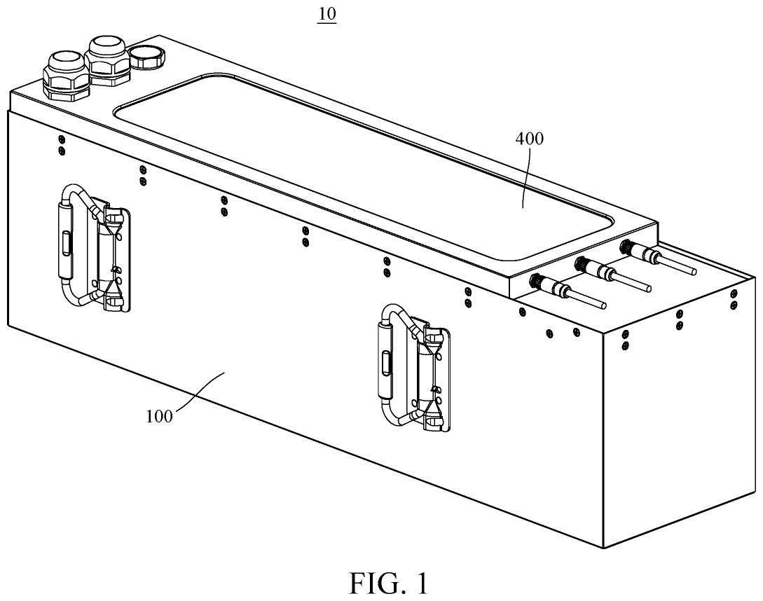

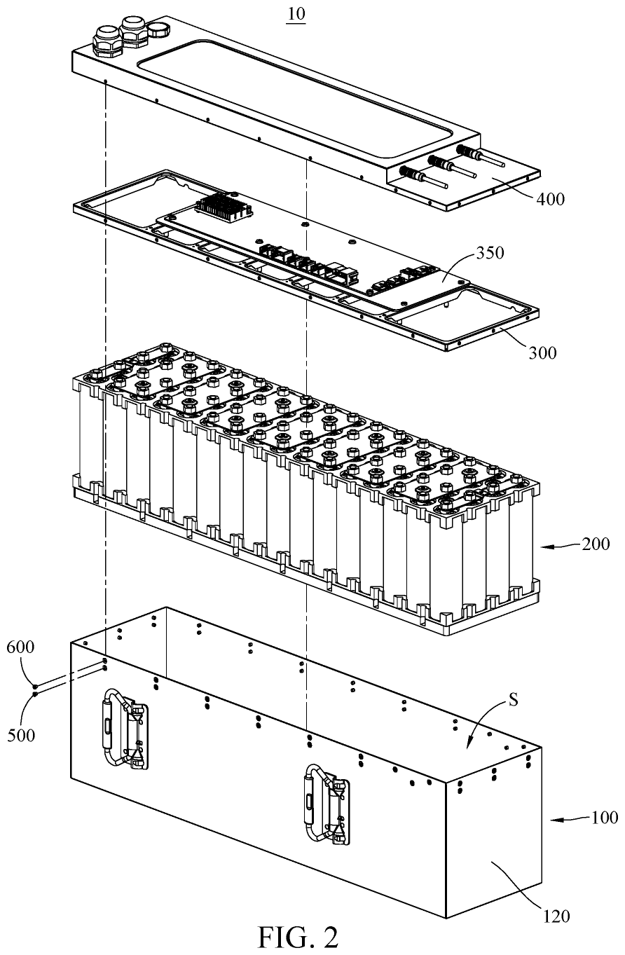

Referring to FIGS. 1 to 6, there are shown a perspective view of a power supply device 10 according to one embodiment of the invention, an exploded view of the power supply device 10 in FIG. 1, and cross-sectional views of the power supply device 10 in FIG. 1.

In this embodiment, the power supply device 10 is, for example, applied in a vehicle, such as autonomous driving car, electric car, or semi-autonomous driving car. When the vehicle travels on the bumpy road, the bumpy road may cause the power supply device 10 to vibrate. Therefore, the power supply device 10 is required to have a strong structure strength to resist the vibration. The following paragraphs will introduce the power supply device 10.

As shown in FIGS. 1 to 3, the power supply device 10 includes a casing 100, a battery module 200, and a cover 400. In addition, the power supply device 10 may further include a mount frame 300, a power management assembly 350, and fasteners 500 and 600.

The casing 100 includes a bottom plate 110, an annular side plate 120, and a plurality of first positioning structures 130. The annular side plate 120 is connected to a periphery of the bottom plate 110, such that the bottom plate 110 and the annular side plate 120 together form an accommodation space S. The first positioning structures 130 protrude from the bottom plate 110 and located in the accommodation space S.

The battery module 200 is located in the accommodation space S, and the bottom of the battery module 200 is in contact with the bottom plate 110 of the casing 100, and the lateral sides of the battery module 200 are in contact with the annular side plate 120 of the casing 100. The battery module 200 includes a bottom frame 220, a plurality of battery units 210 and a top frame 230. The bottom frame 220 is fixed to the casing 100. The battery units 210 are, for example, lithium battery unit. The battery units 210 are located between and fixed in position by the bottom frame 220 and the top frame 230, such that the bottom frame 220, the battery units 210, and the top frame 230 together form one modular body.

In this embodiment, the battery module 200 may further include a plurality of supports 240, a plurality of first fasteners 250, and a plurality of second fasteners 260. Ends of the supports 240 are fixed to the bottom frame 220 via the first fasteners 250 respectively, and the other ends of the supports 240 are fixed to the top frame 230 via the second fasteners 260 respectively. By doing so, the structural strength of the battery module 200 can be increased. In addition, the supports 240 and the battery units 210 are in a staggered arrangement.

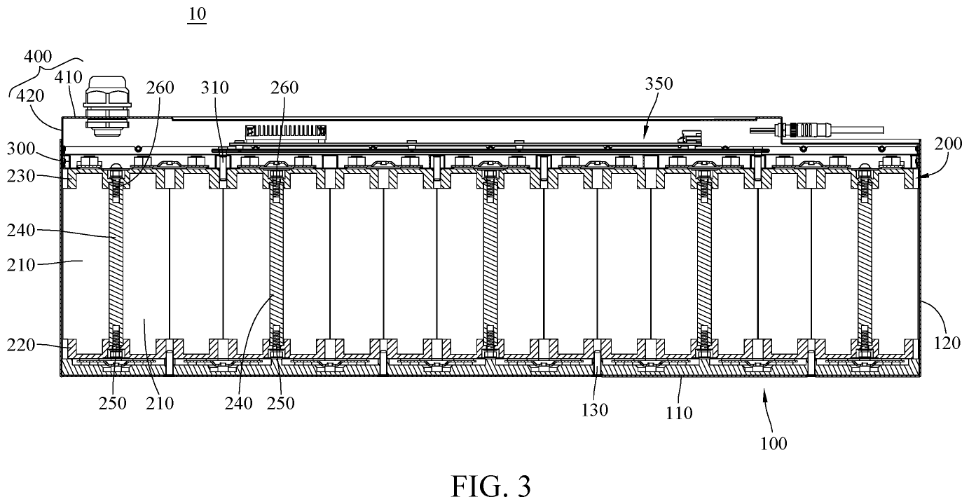

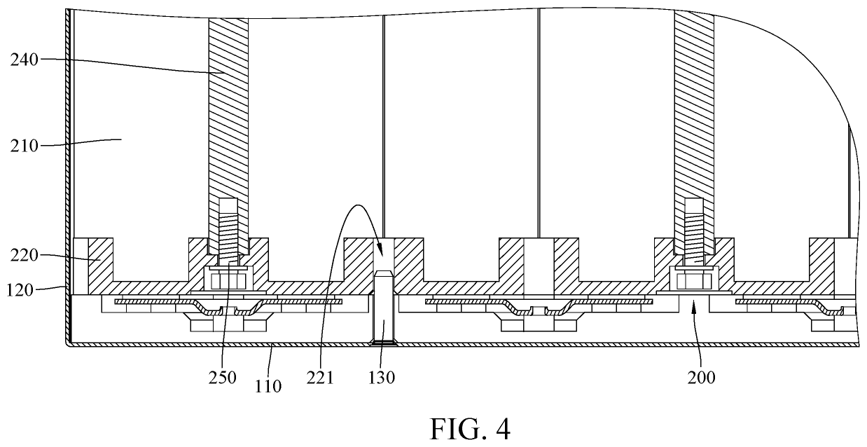

As shown in FIGS. 3 and 4, in the embodiment, the bottom frame 220 has a plurality of second positioning structures 221. The second positioning structures 221 are, for example, recesses, and the first positioning structures 130 are, for example, pillars. The first positioning structures 130 are respectively inserted into the second positioning structures 221 so as to limit the movement of the battery module 200 in a horizontal direction. In this embodiment, the first positioning structures 130 and the second positioning structures 221 are small in size and can be manufactured with high precision, such that the cooperation of the first positioning structures 130 and the second positioning structures 221 can firmly position the battery module 200. Moreover, the annular wall portion 420 surrounds the battery module 200, such that the annular wall portion 420 can also limit the movement of the battery module 200 in the horizontal direction. Therefore, the battery module 200 can resist the vibration in the horizontal direction.

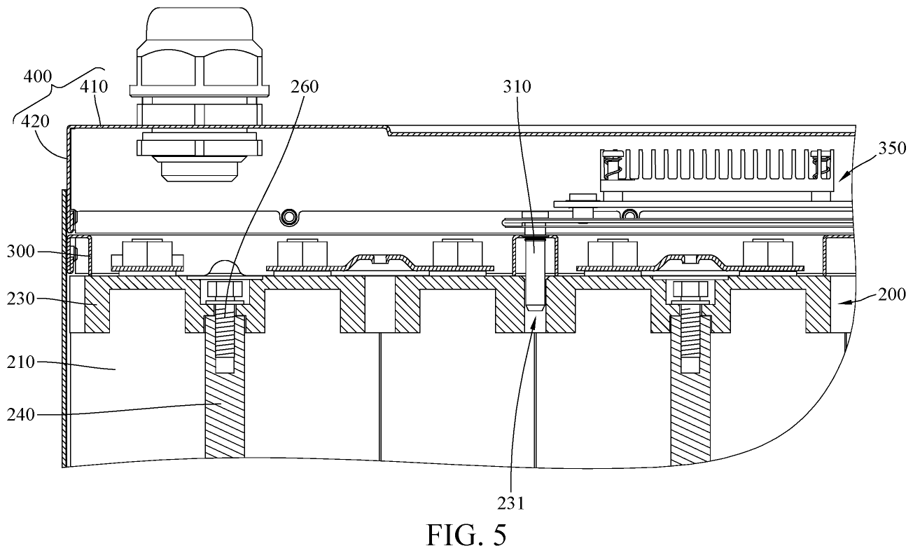

As shown in FIGS. 3 and 5, the mount frame 300 is mounted on the casing 100 and presses against the top frame 230 of the battery module 200, such that the battery module 200 is clamped by the mount frame 300 and the bottom plate 110 of the casing 100, thereby limiting the movement of the battery module 200 in a vertical direction. By doing so, the battery module 200 can resist the vibrations in the horizontal direction and the vertical direction while the vehicle travels on the bumpy road.

In this embodiment, the mount frame 300 may have a plurality of third positioning structures 310, and the top frame 230 may have a plurality of fourth positioning structures 231. The fourth positioning structures 231 are, for example, recesses, and the third positioning structures 310 are, for example, pillars. The third positioning structures 310 are respectively inserted into the fourth positioning structures 231 so as to limit the movement of the battery module 200 in the horizontal direction.

The power management assembly 350 is disposed on the mount frame 300 and electrically connected to the battery module 200 for managing the battery module 200.

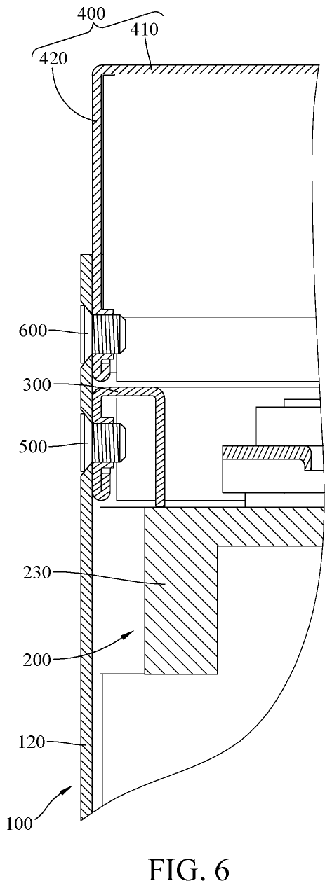

As shown in FIGS. 3 and 6, the mount frame 300 is fixed on the annular side plate 120 of the casing 100 via the fastener 500. The cover 400 includes a top portion 410 and an annular wall portion 420. The annular wall portion 420 of the cover 400 is connected to a periphery of the top portion 410 of the cover 400. The annular wall portion 420 of the cover 400 is fixed on the annular side plate 120 of the casing 100 via the fastener 600. The cover 400 covers the accommodation space S. The annular wall portion 420 of the cover 400 is located close to or in contact with a side of the mount frame 300 located away from the top frame 230.

In the battery module 200, the bottom frame 220 and the top frame 230 are assembled with each other via the supports 240, the first fasteners 250, and the second fasteners 260, but the present invention is not limited thereto; in some other embodiments, the bottom frame and the top frame of the battery module may be assembled with each other via a rigid plate, such as a frame.

Note that the quantities of the first positioning structures 130, the second positioning structures 221, the third positioning structures 310, the fourth positioning structures 231, the supports 240, the first fasteners 250, and the second fasteners 260 are not restricted, and the quantity of each of them may be modified to be one in some other embodiments.

According to the power supply device and the battery module as discussed in the above embodiment, the battery unit are located between and fixed in position by the bottom frame and the top frame, such that the bottom frame, the battery units, and the top frame together form one modular body. Therefore, the battery module of the power supply device can effectively resist the vibrations.

Moreover, the cooperation of the first positioning structures and the second positioning structures can limit the movement of the battery module in the horizontal direction. In addition, the first positioning structures and the second positioning structures are small in size and can be manufactured with high precision, such that the battery module can be firmly positioned by the first positioning structures and the second positioning structures. Furthermore, the annular wall portion surrounds the battery module, such that the annular wall portion can also limit the movement of the battery module in the horizontal direction. Therefore, the battery module can resist the vibration in the horizontal direction.

On the other hand, the battery module is clamped by the mount frame and the bottom plate of the casing, thereby limiting the movement of the battery module in the vertical direction. Accordingly, the battery module can resist the vibrations in the horizontal direction and the vertical direction while the vehicle travels on the bumpy road.

In addition, the third positioning structures are respectively inserted into the fourth positioning structures, such that the cooperation of the third positioning structures and the fourth positioning structures can also limit the movement of the battery module in the horizontal direction.

It will be apparent to those skilled in the art that various modifications and variations can be made to the present invention. It is intended that the specification and examples be considered as exemplary embodiments only, with a scope of the invention being indicated by the following claims and their equivalents.

What is claimed is:

1. A power supply device, comprising:
a casing, having an accommodation space;
a battery module, located in the accommodation space and comprising a bottom frame, a plurality of battery units, and a top frame, wherein the bottom frame is fixed to the casing, and the plurality of battery units are located between and fixed in position by the bottom frame and the top frame; and
a cover, mounted on the casing and covering the accommodation space.

2. The power supply device according to claim 1, wherein the battery module further comprises at least one support, at least one first fastener, and at least one second fastener, an end of the at least one support is fixed to the bottom frame via the at least one first fastener, and another end of the at least one support is fixed to the top frame via the at least one second fastener.

3. The power supply device according to claim 1, wherein the casing comprises a bottom plate, an annular side plate, and at least one first positioning structure, the annular side plate is connected to a periphery of the bottom plate, the at least one first positioning structure protrudes from the bottom plate, the bottom frame has at least one second positioning structure, and the at least one second positioning structure is engaged with the at least one first positioning structure.

4. The power supply device according to claim 3, further comprising a mount frame, wherein the mount frame is mounted on the casing and presses against the top frame of the battery module.

5. The power supply device according to claim 4, wherein the cover comprises a top portion and an annular wall portion, the annular wall portion of the cover is connected to a periphery of the top portion of the cover, and the annular wall portion of the cover is located close to or in contact with a side of the mount frame located away from the top frame.

6. The power supply device according to claim 5, wherein the mount frame has at least one third positioning structure, the top frame has at least one fourth positioning structure, and the at least one fourth positioning structure is engaged with the at least one third positioning structure.

7. The power supply device according to claim 4, further comprising a power management assembly disposed on the mount frame.

8. A battery module, comprising:
a bottom frame;
a plurality of battery units; and
a top frame, wherein the plurality of battery units are located between and fixed in position by the bottom frame and the top frame.

9. The battery module according to claim 8, further comprising at least one support, at least one first fastener, and at least one second fastener, wherein an end of the at least one support is fixed to the bottom frame via the at least one first fastener, and another end of the at least one support is fixed to the top frame via the at least one second fastener.

10. The battery module according to claim 9, wherein the at least one support comprises a plurality of supports, the at least one first fastener comprises a plurality of first fasteners, the at least one second fastener comprises a plurality of second fasteners, and the plurality of supports and the plurality of battery units are in a staggered arrangement.
